(19) United States
(12) Patent Application Publication
(10) Pub. No.: US 2005/0118397 A1
(43) Pub. Date: Jun. 2, 2005

(54) Repairable thermoplastic material

(76) Inventor: David James Horwitz, Savannah, GA (US)

Correspondence Address: J. BENNETT MULLINAX, LLC, P. O. BOX 26029, GREENVILLE, SC, 29616-1029, US

(21) Appl. No.: 10/726,120

(22) Filed: Dec. 2, 2003

(51) Int. Cl. B32B 3/30

(52) U.S. Cl. 428/167

(57) ABSTRACT

An isotropic thermoplastic article such as a sheet of extruded polyvinyl chloride is provided in which the surface of the sheet defines a plurality of fine, parallel grooves. The grooves provide a textured finish to the sheet on which scratches and other surface flaws may be repaired using sandpaper or similar abrasives. By applying the abrasive in the direction of the grooves, the surface flaw may be removed. The resulting repaired area maintains a surface texture and finish which matches the surrounding original surface.

### FIELD OF THE INVENTION

This invention is directed towards thermoplastic sheets, laminates using the thermoplastic sheets, and useful articles made from the thermoplastic sheets including furniture, case goods, tabletops, flooring, wainscoting, door panels, and other building materials. The invention is more particularly directed to a thermoplastic material having a simulated wood or marble grain pigmentation in which the surface finish of the laminate is repairable without noticeable degradation of the surface appearance or ornamentation.

### BACKGROUND OF THE INVENTION

A wide variety of materials are used in the construction of tables, case goods, cabinetry, desks, shelves, flooring, and related items. Such items may be constructed from relatively low cost materials such as plastic molded units and particle board laminated constructions to mid-range wooden or plastic laminates to higher end premium wood or metal construction.

It is known in the art to use extruded sheets of polyvinyl chloride (PVC) to create furniture and other case goods. The thermoplastic PVC materials may be pigmented so as to provide a wide number of color combinations including a simulated wood grain pigmentation.

One advantage of thermoplastic materials is that scratches and other surface flaws may be removed by using steel wool or other buffing material to restore the surface of the damaged article to an improved, repaired finished. Some thermoplastic materials such as table legs, arm rests, and other small surfaces are more easily repaired in that the repaired surface is not noticeably different from the surrounding area. However, for larger surfaces such as tabletops, shelving, and other, broader surfaces, the repaired area is noticeably different from the surrounding areas. For instance, a matte finely grained pebble appearance finish on a thermoplastic material will frequently leave a high gloss, shiny area following repair. A smooth finish thermoplastic sheet, when repaired, forms a dull spot having a noticeably reduced gloss and shine. For such surfaces, while the damaged area may be removed and hence “repaired”, the repaired location appears visibly different.

Many synthetic wood finish substrates use high pressure laminates in which a hardened exterior coating is placed over a paper substrate having a wood grain image printed thereon. When a high pressure laminate substrate is damaged, the damaged area cannot be restored to an original quality appearance. For instance, efforts to remove a minor scratch in the surface coating brings about a region which is noticeably different in terms of finish qualities such as gloss than the original laminate surface. Further, to the extent the damage extends to the underlying paper substrate, such damage cannot be repaired to match the original finish.

Wood articles typically can be repaired and restored to their original finish, but require a great deal of effort and cost. For instance, while a scratch or abrasion can be successfully removed through sanding, the repaired area may need to be restained and refinished so as to match the original appearance of the article. The staining and refinishing techniques require specialized skill in order to successfully repair a finished wooden substrate.

With respect to thermoplastic sheets on laminates made therefrom, one strategy to minimize damage is to increase the hardness of the sheet surface. In this manner, the number and severity of surface flaws may be reduced. One such approach is disclosed in Applicant's co-pending application having Ser. No. 10/151,506, filed on May 20, 2002, and which is incorporated herein by reference. While a more scratch resistant surface offers numerous advantages, it is not possible to manufacture a thermoplastic sheet which is totally resistant to surface imperfections and damage. Accordingly, there remains room for improvement and variation in the art with respect to thermoplastic sheets and laminates therefrom used in the construction of furniture, tabletops, flooring, and other materials.

### SUMMARY OF THE INVENTION

It is one aspect of at least one of the present embodiments to provide a thermoplastic sheet having a simulated grain appearance which has an upper surface defining a plurality of substantially parallel linear surface etchings.

It is yet another aspect of at least one of the present embodiments of the invention to provide for a thermoplastic sheet having an enhanced repairable surface comprising an embossed surface finish, the surface finish characterized by a plurality of substantially parallel lines formed in the laminate's surface. Optionally, the thermoplastic sheet may have an integral pigmented appearance such as a wood grain or marble finish.

It is yet another aspect of at least one of the present embodiments of the invention to provide a thermoplastic sheet having a randomly embossed surface finish which facilitates restoration of the finish without degradation of the repaired area's appearance.

It is yet another aspect of at least one of the present embodiments to provide for an isotropic thermoplastic sheet having a surface finish comprising a series of substantially linear etched lines or grooves, the linear finish allowing subsequent surface repairs without leaving noticeable signs of repair. In one embodiment, the linear finish is provided by an embossing roller which creates the plurality of fine lines formed within the surface. Alternatively, an abrasive such as a 220 grit sandpaper may be used to create a plurality of fine lines in the surface finish.

These and other features, aspects, and advantages of the present invention will become better understood with reference to the following description and appended claims.

### BRIEF DESCRIPTION OF THE DRAWINGS

A fully and enabling disclosure of the present invention, including the best mode thereof, to one of ordinary skill in the art, is set forth more particularly in the remainder of the specification, including reference to the accompanying drawings.

FIG. 1 is a plan view of a thermoplastic sheet showing the surface finish according to the present invention.

FIG. 1A is an enhanced view of the sheet surface seen in FIG. 1.

FIG. 2 is a cross section taken along lines 2-2 of FIG. 1 showing additional details of the surface structure of the thermoplastic sheet.

FIG. 3 is a plan view of an alternative pattern for a surface finish which may be provided by an embossing roller having a similar pattern defined on a surface of the roller, or by application of an abrasive substance such as sandpaper.

FIG. 4 is a comparative surface view of a high pressure laminate tabletop in comparison to an adjacent tabletop made in accordance with the present invention. The lower half of each table has been sanded to correct the surface damage as seen in reference to the upper half of each respective table.

### DESCRIPTION OF THE PREFERRED EMBODIMENT

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus or process pathway. To avoid redundancy, detailed descriptions of much of the apparatus once described in relation to a figure are not repeated in the descriptions of subsequent figures, although such apparatus or process is labeled with the same reference numbers.

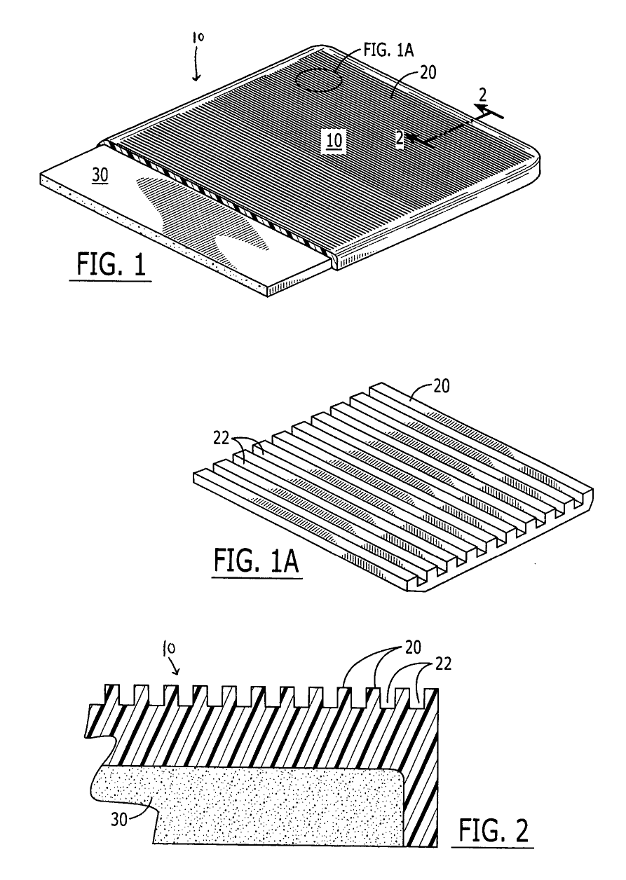

As seen in reference to FIGS. 1 and 1A, a thermoplastic isotropic sheet 10 is provided of a thermoplastic material such as polyvinyl chloride. While the use of PVC has been found useful for embodiments directed to sheets used in the construction of case goods, furniture, and foam laminates, it is believed that any thermoplastic material having adequate structural rigidity at room temperature for similar products will suffice. Similarly, for most applications it is preferred that the thermoplastic sheet have a high Shore D hardness value so as to be resistant to scratches and surface damage. However, it is envisioned within the scope of the present invention that thermoplastic sheets having relatively low Shore D hardness values can also be easily restored and repaired in keeping with the teachings of the present invention.

As seen in reference to FIGS. 1 and 3, the thermoplastic isotropic sheet 10 may be used to form a laminate with a lower backing layer 30. One such laminate may be formed using a urethane foam applied to a lower surface of sheet 10. However, sheet 10 may be applied to other materials including particle board, additional sheets of thermoplastic materials to form a multi-layer laminate, or applied to a wide variety of other backing materials so as form a laminate by the backing substrate and the joined sheet 10. The particular nature of the backing material 30 may be varied depending upon the end application and use of the sheet 10 described herein. For instance, when the sheets 10 are used as the outer skins for a manufactured door, the backing 30 may include any of the traditional materials used to form an interior or exterior door. With respect to flooring, backing 30 may be provided from a resilient, sound deafening material which promotes easy installation of the resulting flooring over a subfloor.

While various backings 30 may be useful for certain applications, such backings are optional and may merely supplement the existing useful features of individual thermoplastic sheets having the surface etchings and grooves as described herein.

As further seen in reference to FIGS. 1 and 1A, sheet 10 has an upper surface 20 which defines a plurality of substantially straight, parallel grooves or lines 22. Sheet 10 may be of any desired thickness. When used as a laminate for furniture, a thickness of a PVC sheet of between about 1 to about 2 mm is useful. The PVC sheet has a Shore D hardness value of about 80 to about 85. The grooves 22 may be formed by a variety of techniques such as an embossing roller or a fine grade abrasive such as a 220 grit sandpaper. Other materials and techniques for creating the surface texture pattern may include the use of steel wool, a die stamping press, sandblasting, laser ablation, or a series of fine blades or other cutting instruments. Any technique which brings about a corresponding surface structure whether by etching, cutting, carving, melting, pressing, abrading, or a combination of such techniques will suffice to confer the desired properties to the isotropic sheet.

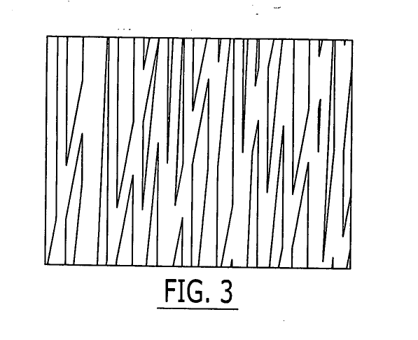

As best seen in reference to FIG. 1A, the grooves 22 extend substantially parallel and have a depth of between about 25 to about 100 microns and more preferably about 50 to about 75 microns. The width of each groove is about 20 to about 120 microns. The distance between each groove 22 may vary, but in the embodiments disclosed herein an average distance between grooves of about 0 to about 20 microns has been found useful. When using an embossing roller having an average groove spacing of about 0 to about 20 microns (FIG. 3), it has been found useful to provide a complementary embossing roller in which the groove pattern depth is between about 25 to about 40 microns. Preferably, the grooves 22 all have approximately the same depth. However, variations of groove depth, groove spacing, and groove width across a surface may also be used and provides an adequate surface for repairing surface flaws. As seen in reference to FIG. 2, an optional backing 30 such as a structural hard polyurethane foam, fabric, wood, particle board, thermoplastic material, and rubber may be provided. The use of polyurethane foam in the production of thermoplastic laminates is described in Applicant's previously filed applications as referenced elsewhere in this application.

The isotropic sheet 10 may also have a pigmented, simulated grain such as a wood grain. The use of pigmented thermoplastic pellets to impart a wood grain appearance is described in Applicant's co-pending application having U.S. Ser. No. 10/305,481, filed on Nov. 27, 2002, and which is incorporated herein by reference.

As seen in reference to FIG. 2, the grooves 22 are illustrated as being substantially square bottom channels established within the surface of the sheet. The shape of the grooves 22 can be varied so as to take on a variety of alternative shapes including groove profiles which are curved or have other angled edgewalls used to define the groove. Similarly, sheet 10 has an upper surface 20 positioned between grooves 22 may have a substantially square profile as illustrated or be provided with a more rounded edgewall adjacent the grooves 22. While not separately illustrated, it is within the scope of the present invention that the portions of surface 20 defined between each groove 22 may additionally comprise a shallower groove therein so as to provide a sheet surface having a plurality of different depth grooves. Again, variation in the shape of the groove and that shape of the edgewalls defining the grooves may be varied depending upon the desired application and surface ornamentation.

The formation of an isotropic sheet having an ornamental surface comprising a plurality of closely spaced grooves allows the thermoplastic material to be easily repaired. Since the isotropic material is uniform throughout the sheet, any optional wood or marble grain pattern or other pigmentation is uniform throughout the sheet. As such, removing a portion of a surface of the resulting sheet does not bring about a degradation of appearance since the color, texture, and other properties of the finished sheet are uniform throughout the sheet material. In this manner, when a portion of the sheet surface is “refinished” by sanding or some other abrasive technique, the newly formed surface matches the surrounding area in terms of surface texture, pigmentation, gloss, and other noticeable physical properties.

The grooves 22 may be formed into one or more of the surfaces of sheet 10 using an embossing roller and applied to the sheet using heat and pressure having the desired pattern defined on the roller surface. Such roller patterns may include a plurality of parallel regions so as to form the corresponding grooves as seen in FIG. 1. In addition, an alternative pattern to surface 20 may be seen in reference to FIG. 3. The pattern seen in FIG. 3 comprises a series of substantially parallel grooves in which some grooves intersect or cross at angles up to about 10 degrees. A small percentage of the grooves which randomly intersect adjacent lines at an angle of about 2 degrees to about 10 degrees has been found to offer a useful surface texture pattern. While an average distance between the grooves of about 0 to about 20 microns is useful, it is apparent to one having ordinary skill in the art that to the extent a portion of the grooves intersect, such embodiments will have a greater variation in the widths between the grooves.

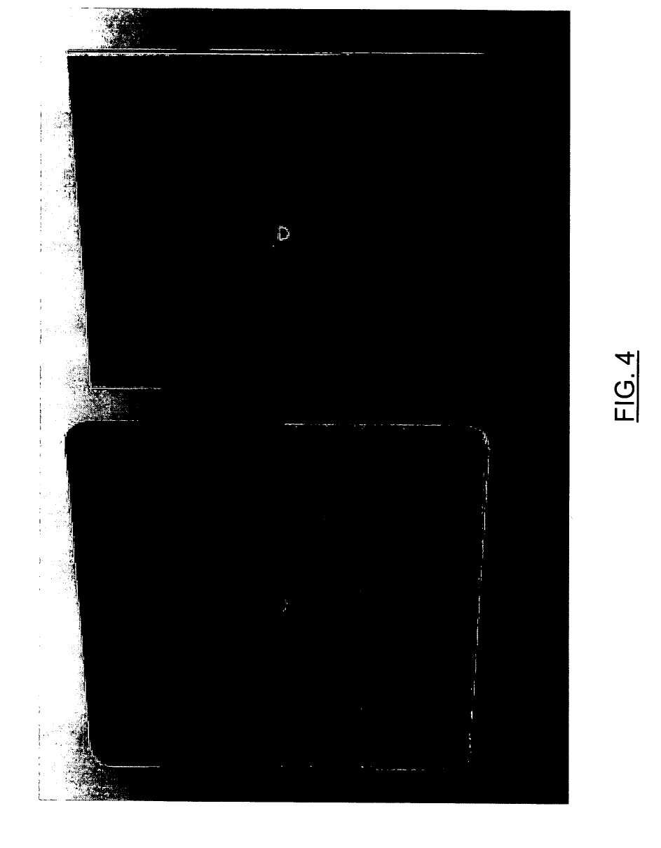

The sample surface pattern as seen in reference to FIG. 4 may also be formed using an abrasive such as a 220 grit sandpaper applied under pressure to the surface of the sheet 10. The sandpaper may be used manually, with mechanical sanders, or mounted to a roller which rotates along the upper surface of sheet 10. The use of sandpaper in this manner provides for a sheet surface having a more random appearance similar to the surface pattern seen in FIG. 3. Alternatively, an abrasive grit roller may be used to create the desired pattern.

The surface pattern as seen in reference to FIG. 3 has been found to closely match the pattern of grooves formed when sandpaper is applied to a smooth surface of an isotropic sheet. By establishing a preexisting groove pattern in the surface similar to the pattern formed by a sanding process, the resulting repaired region more closely matches the surrounding non-repaired surface region. As a result, repairs to surface scratches, abrasions, and other flaws may be made. Following repair, the repaired surface matches the color, gloss, and surface texture of the surrounding areas.

As a result of the surface pattern provided on the thermoplastic sheets, it is possible to repair not only scratches and flaws, but significant cuts and damaged areas which may extend a significant depth into the sheet/article. As a result, damage which occurs during handling, construction, or shipping of furniture and case goods made using the sheets 10 may be easily and economically repaired. The ability to repair and restore the surface to an original quality condition offers great cost savings. In addition, purchasers of goods having the novel surface texture can rapidly restore flaws or damage which occurs during normal use. As such, the purchased articles have increased value attributable to the ease and quality of repair.

### EXAMPLE 1

As seen in reference to FIG. 4, a side-by-side comparative illustration is provided setting forth a tabletop of a non-isotropic high-pressure laminate material (left) versus an isotropic thermoplastic tabletop having a surface groove pattern similar to that described in reference to FIG. 3. Both tables originally had a circular pattern of damage extending across the respective tabletop surfaces.

A 220 grit sandpaper was applied to both tables in an effort to remove the surface abrasions. As noted, on the comparative high pressure laminate table positioned on the left, the removal of the surface abrasions results in greatly impaired aesthetics of the repaired surface. In contrast, the isotropic laminate material on the right hand surface was restored to a high quality surface finish.

The inclusion of a plurality of fine grooves on the surface of the table seen in the right hand side of FIG. 4 allows a fine sandpaper or similar abrasive to be applied in the direction of the grooves. As the sandpaper is applied, a portion of the upper surface of the table is removed sufficient to remove the surface flaw. The surface removal technique uses an abrasive which creates a pattern of grooves similar to the grooves defining the original textured finish.

It is preferable to apply the surface abrasive in the same direction in which the surface grooves extend. However, since the thermoplastic sheet is an isotropic material, the abrasive can be applied in a cross or angled direction which may more quickly remove a desired portion of the sheet surface. By using final buffing or polishing steps of a fine abrasive in the same direction as the surface grooves, the repaired area's finish can be matched to the appearance of the surrounding grooves. The end product has a repaired region which matches the surrounding original finish in terms of color, gloss, surface texture, and other ornamental features.

The repaired sheet and/or subsequent article incorporating the sheet may be economically restored and, as can be seen in reference to FIG. 4, the repaired region of the surface closely matches the original surface. As a result, flaws and surface defects may be easily restored without impairing the marketability of the item. If desired, high wear areas of an article such as table legs, drawer fronts, and furniture bases may be provided with a surface finish of parallel grooves as defined herein. In this manner, the high wear areas of an article such as the legs or edges of a desk can be made with the grooved surface pattern which is easily repaired. In the same article, a portion of the article such as a desk surface can be provided with a traditional flat finish so as to provide a smooth writing surface and/or a desirable high gloss finish.

The ease of repair is an enormous advantage for manufacturers and retailers of furniture and case goods who are able to restore goods to original market quality. Likewise, purchasers of such products also have the ability to repair scratches, abrasions, and other surface damage using straightforward techniques and material.

The thermoplastic sheets having the surface features described herein may be used to provide a variety of useful products and articles. The repairable nature of the surface makes the thermoplastic sheet materials ideal for use as a wood substitute on a variety or products. Such products include furniture, case goods, countertops, tabletops, plank or tile flooring, door exteriors, and other building or furniture materials which may traditionally be formed from wood, particle board, or high pressure laminates. For use in high wear areas such as flooring, it is of course desirable to provide a flooring material out of a thermoplastic sheet having the best wear resistant properties possible.

In accordance with this invention, it is believed that the present invention lends itself to providing thermoplastic sheets which can be repaired or restored in a manner similar to traditional wood products. However, unlike traditional wood products, restoration and refinishing can be done quickly and without delays needed for multiple drying and/or stain steps. For instance, thermoplastic flooring panels made in accordance with the present invention would, over time, have the upper surface worn in high traffic areas. Using a mechanical sander and/or fine engraving tool, it is believed possible to resurface the worn regions of a thermoplastic floor by reestablishing the surface pattern of grooves. The resurfacing not only removes and restores damaged areas, but recreates a new surface finish which takes on a “like new” appearance.

Traditional hardwood floor require substantial sanding and surface coating steps which must occur over intervals of several days. A thermoplastic laminate sheet as disclosed herein can be repaired much more quickly and is immediately useable. High pressure laminate flooring depends entirely upon an extremely hard exterior finish to provide scratch and abrasion resistance. While long lasting, should the finish be damaged, the damaged area cannot be repaired in a manner that matches the surrounding area absent replacement of one or more portions of the flooring.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged, both in whole or in part. Therefore, the spirit and scope of the appended claims should not be limited to the description of the preferred versions contained therein.

1. A thermoplastic isotropic sheet comprising:
a sheet of a thermoplastic material having at least one ornamental surface, said ornamental surface further defining a plurality of linear and substantially parallel grooves defined within said ornamental surface of said sheet.

2. The sheet according to claim 1 wherein said plurality of grooves have a depth of about 25 to about 100 microns.

3. The sheet according to claim 1 wherein said plurality of grooves have a depth of about 25 to about 40 microns.

4. The sheet according to claim 1 wherein said plurality of grooves are spaced a distance apart of about 0 to about 20 microns.

5. The sheet according to claim 4 wherein said plurality of grooves have a depth of about 25 to about 100 microns.

6. The sheet according to claim 4 wherein said plurality of grooves have a depth of about 25 to about 40 microns.

7. A process of producing a thermoplastic article having a repairable surface comprising:
forming a thermoplastic material into a shaped article;
texturing at least one surface of said shaped article by the formation of a plurality of linear, substantially parallel grooves in said at least one surface of the shaped article;
wherein said shaped article has at least one surface of grooves which, when repaired using an abrasive, a repaired surface matches a finish of the surrounding surface.

8. The shaped article according to claim 7 wherein said plurality of grooves have a depth of about 25 to about 100 microns.

9. The shaped article according to claim 7 wherein said plurality of grooves have a depth of about 25 to about 40 microns.

10. The shaped article according to claim 7 wherein said plurality of grooves are spaced a distance apart of about 0 to about 20 microns.

11. The shaped article according to claim 10 wherein said plurality of grooves have a depth of about 25 to about 100 microns.

12. The shaped article according to claim 10 wherein said plurality of grooves have a depth of about 25 to about 40 microns.

13. A process of repairing a flaw within a surface of a thermoplastic article comprising:
providing an article having at least one thermoplastic surface, said thermoplastic surface having a surface texture comprising a plurality of substantially parallel grooves;
locating a flaw within the thermoplastic surface;
applying an abrasive substrate to a location of the flaw within the thermoplastic surface, the abrasive substrate applied in a direction corresponding to a direction of said parallel grooves;
continuing application of an abrasive substrate until said flaw is removed;
wherein, an area where said flaw is removed matches the surface finish of the adjacent surface.

14. The thermoplastic article according to claim 13 wherein said plurality of grooves have a depth of about 25 to about 100 microns

15. The thermoplastic article according to claim 13 wherein said plurality of grooves have a depth of about 25 to about 40 microns.

16. The thermoplastic article according to claim 13 wherein said plurality of grooves are spaced a distance apart of about 0 to about 20 microns.

17. The thermoplastic article according to claim 16 wherein said plurality of grooves have a depth of about 25 to about 100 microns.

18. The thermoplastic article according to claim 16 wherein said plurality of grooves have a depth of about 25 to about 40 microns.

19. The sheet according to claim 1 wherein said sheet further comprises a backing material adhered to a lower surface of said sheet.

20. The sheet according to claim 19 wherein said backing material is selected from the group consisting of foam, fabric, wood, particle board, thermoplastic material, and rubber.

21. The process according to claim 7 wherein said process comprises the additional step of applying a backing material to said shaped article, thereby forming a laminate.
